(19) United States
(12) Patent Application Publication
(10) Pub. No.: US 2019/0311693 A1
(43) Pub. Date: Oct. 10, 2019

(54) VEHICLE INFORMATION OUTPUT DEVICE AND VEHICLE INFORMATION OUTPUT SYSTEM

(71) Applicant: HONDA MOTOR CO., LTD., Tokyo (JP)

(72) Inventors: Tasuku Saka, Wako-shi (JP); Tomohisa Manabe, Wako-shi (JP); Masayuki Morita, Wako-shi (JP)

(21) Appl. No.: 16/371,216

(22) Filed: Apr. 1, 2019

(30) Foreign Application Priority Data
Apr. 6, 2018 (JP) 2018-074133

(51) Int. Cl. G09G 5/00; G06F 3/14

(52) U.S. Cl. CPC G09G 5/005; G06F 3/14; G09G 2330/026; G01C 21/3691; G09G 2354/00; G09G 2370/022; G09G 2340/0407; G09G 2380/10

(57) ABSTRACT

A vehicle information output device (100) includes an output unit (110) configured to output information to inside of a vehicle, a starting unit (104) configured to execute starting processing in a case that the power supply is turned on, a communication unit (120) configured to communicate with an external device via a network, a communication control unit (134) configured to acquire output information stored in the external device via the communication unit, and an output control unit (136) configured to cause the output unit to output the output information acquired by the communication control unit before starting processing by the starting unit is completed.

### CROSS-REFERENCE TO RELATED APPLICATION

Priority is claimed on Japanese Patent Application No. 2018-074133, filed Apr. 6, 2018, the content of which is incorporated herein by reference.

### BACKGROUND

### Field of the Invention

The present invention relates to a vehicle information output device and a vehicle information output system.

### Background

In an in-vehicle apparatus such as a navigation device mounted on a vehicle, starting processing for starting the apparatus is performed before the apparatus becomes available to use after a power supply is turned on. This type of in-vehicle apparatus often does not receive an operation during starting processing, and a user needs to wait during the starting processing. In relation to this, a technology for causing a display screen to display a predetermined image during starting processing of an in-vehicle apparatus is known (for example, refer to Japanese Unexamined Patent Application, First Publication No. 2004-145120 and Japanese Unexamined Patent Application, First Publication No. 2006-284314).

### SUMMARY

However, although different starting images are displayed each time while starting processing of an in-vehicle terminal from power-on until start of use is executed in the conventional technology, display contents thereof do not reflect the preferences of a user.

The present invention has been made in view of such circumstances, and an object thereof is to provide a vehicle information output device and a vehicle information output system which can more flexibly determine information to be output after power is turned on until they are ready for use.

A vehicle information output device and a vehicle information output system according to the present invention will adopt the following configuration.

(1): A vehicle information output device according to one aspect of the present invention includes an output unit configured to output information to inside of a vehicle, a starting unit configured to execute starting processing in a case that the power supply is turned on, a communication unit configured to communicate with an external device via a network, a communication control unit configured to acquire output information stored in the external device via the communication unit, and an output control unit configured to cause the output unit to output the output information acquired by the communication control unit before starting processing by the starting unit is completed.

(2): In the aspect of (1) described above, an operation of a user is receivable after the starting processing executed by the starting unit is completed.

(3): In the aspect of (1) described above, a selection unit configured to select the output information according to a type is further included, and the output control unit causes the output unit to output an image based on the output information selected by the selection unit.

(4): In the aspect of (3) described above, a priority is set for the output information in accordance with a type of the output information in a case that the output information is transmitted to a server by a user, and the selection unit selects the output information on the basis of the priority.

(5): In the aspect of (3) described above, the selection unit preferentially selects the output information transmitted to a server by an operation of a user.

(6): In the aspect of (3) described above, the selection unit preferentially selects the output information in a new transmission order of the output information transmitted to a server by the operation of a user.

(7): In the aspect of (3) described above, in a case that the output information is a schedule of a user, the selection unit preferentially selects the schedule in chronological order.

(8): In the aspect of (3) described above, in a case that a destination of the vehicle is set, the selection unit preferentially selects a schedule while a user is moving and a schedule after the user arrives at the destination.

(9): A vehicle information display system according to another aspect of the present invention is a vehicle information display system including a vehicle information display device mounted on a vehicle and a server capable of communicating with the vehicle, and the vehicle information display device includes an output unit configured to output information to inside of the vehicle, a starting unit configured to execute starting processing in a case that the power supply is turned on, a communication unit configured to communicate with the server via a network, a communication control unit configured to acquire output information stored in the server via the communication unit, and an output control unit configured to cause the output unit to output the output information acquired by the communication control unit before starting processing by the starting unit is completed.

According to the aspects of (1) to (9), it is possible to more flexibly determine information to be output after power is turned on until the vehicle information output device and the vehicle information output system are ready for use.

According to the aspect of (3) described above, it is possible to output various types of information after power is turned on until the vehicle information output device is ready for use.

According to the aspects of (4) to (6), it is possible to output information conforming to preference of a user.

According to the aspects of (7) and (8), it is possible to improve convenience for a user by displaying a schedule of a user from power is turned on until the vehicle information output device is ready for use.

### BRIEF DESCRIPTION OF THE DRAWINGS

FIG. 1 is a block diagram which shows an example of a configuration of a vehicle information output system to which a vehicle information output device is applied.

FIG. 2 is a diagram which shows an example of display contents of a display image displayed on an output unit.

FIG. 3 is a diagram which shows an example of the display contents of a display image displayed on an output unit.

FIG. 4 is a diagram which shows an example of contents of a setting screen of a terminal device for setting output information.

FIG. 5 is a diagram which shows an example of contents of setting information.

FIG. 6 is a diagram which shows an example of the display contents of a display image displayed on an output unit.

FIG. 7 is a flowchart which shows an example of a flow of processing executed in the vehicle information output system.

FIG. 8 is a diagram which shows an example of a hardware configuration of the vehicle information output device.

### DETAILED DESCRIPTION OF THE INVENTION

### First Embodiment

Hereinafter, an embodiment of a vehicle information output device and a vehicle information output system of a first embodiment will be described with reference to drawings.

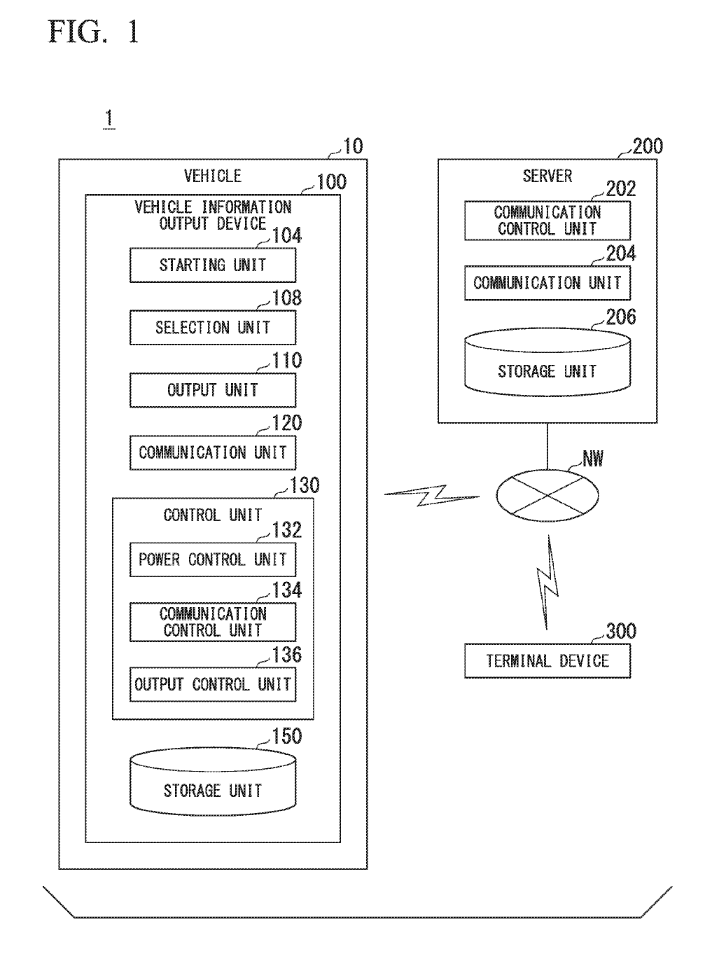

FIG. 1 is a block diagram which shows an example of a configuration of a vehicle information output system 1 to which a vehicle information output device 100 is applied. The vehicle information output system 1 includes a vehicle information output device 100 mounted on a vehicle 10, and a server 200 connected to the vehicle information output device 100 via a network NW. A user's terminal device 300 may also be connected to the server 200 via the network NW. The vehicle information output device 100 is a device which displays information by receiving an operation of a user inside the vehicle 10. The vehicle information output device 100 may also be a virtual device included in a navigation device.

The network NW includes, for example, some or all of a wide area network (WAN), a local area network (LAN), the Internet, a dedicated line, a radio base station, and a provider.

The vehicle information output device 100 includes, for example, a starting unit 104, a selection unit 108, an output unit 110, a communication unit 120, a control unit 130, and a storage unit 150. Each component of the starting unit 104, the selection unit 108, and the control unit 130 is realized, for example, by a processor such as a central processing unit (CPU) executing a program (software). This functional unit may be realized by hardware such as a large scale integration (LSI), an application specific integrated circuit (ASIC), or a field-programmable gate array (FPGA), and may also be realized by software and hardware in cooperation.

The starting unit 104 performs starting processing of the vehicle information output device 100 (executes a starting sequence) in a case that the power supply is changed from an OFF state to an ON state. The starting processing is processing executed before system software including an operation system (OS) of the vehicle information output device 100 starts, such as recognition of a peripheral device or initialization of a memory parameter after the power supply is turned on. If the starting processing ends, the vehicle information output device 100 is in a state of receiving the operation of a user. The operation of a user may be input by voice in addition to being manually input to the vehicle information output device 100 by a user.

The selection unit 108 selects output information for causing the output unit 110 to output information conforming to a preference of a user during the starting processing on the basis of setting information transmitted by the operation of the user.

The output unit 110 includes a display, a speaker, and the like provided inside a vehicle, and is a device that transmits information using videos, images, text, audio, and the like. The output unit 110 is, for example, a touch panel type liquid crystal display in which a speaker is installed, operates in conjunction with the vehicle information output device 100, receives the operation of an occupant, and displays information. The display of a navigation device may also serve as the output unit 110.

The control unit 130 includes, for example, a power control unit 132, a communication control unit 134, and an output control unit 136. The power control unit 132 controls ON or OFF of the power supply to the vehicle information output device 100, that is, power supply with respect to the entire vehicle information output device 100.

The communication control unit 134 controls, for example, communication with an external device outside a vehicle. The external device is, for example, a server 200, a terminal device 300, and the like connected to the network NW. The communication control unit 134 accesses the network NW via the communication unit 120 provided in the vehicle 10, and communicates with the server 200.

The output control unit 136 acquires output information stored in the server 200 on the basis of a selection result of the selection unit 108. Contents of the output information will be described below. The output control unit 136 causes the output unit 110 to output the output information.

The storage unit 150 is realized by a storage device such as a hard disk drive (HDD) or a flash memory. The storage unit 150 stores information such as identification information for identifying a user, or priority of output information to be described below set by a user, in addition to the output information.

The communication unit 120 communicates with an external device outside the vehicle 10 or communicates with various server devices via a radio base station using a cellular network, a Wi-Fi (registered trademark) network, a Bluetooth (registered trademark), a dedicated short range communication (DSRC), and the like. The communication unit 120 may be provided in the vehicle information output device 100, and may be provided in a device other than the vehicle information output device 100.

The server 200 connects to the network NW, and provides information to the vehicle information output device 100. The server 200 includes, for example, a communication control unit 202, a communication unit 204, and a storage unit 206.

The communication control unit 202 controls communication with the vehicle information output device 100 which is performed via the network NW. The communication unit 204 is controlled by the communication control unit 202, and transmits information stored in the storage unit 206 to the vehicle information output device 100. The communication unit 204 performs wired communication by connecting to a cable. The communication unit 204 includes a network interface card (NIC) for connecting to the network NW.

The storage unit 206 is a storage device such as a HDD or a flash memory. The storage unit 206 stores output information displayed on the output unit 110, and setting information (refer to FIG. 3) for causing the output unit 110 to display output information. Contents of the setting information will be described below. The output information may include data uploaded from the terminal device 300 by a user, and data stored in advance.

The terminal device 300 is an information terminal device which has a communication function of a mobile phone such as a smartphone, a tablet terminal, or a personal computer. The terminal device 300 communicates with the server 200 via the network NW.

[Operation of Vehicle Information Display System]

Next, the operation of the vehicle information output system 1 will be described. A user operates, for example, the terminal device 300 before getting into the vehicle 10, and uploads output information to be output by the output unit 110 to the server 200 at the time of starting processing. The server 200 individually identifies the terminal device 300, identifies a user, and stores uploaded output information in the storage unit 206 for each user.

The output information uploaded to the server 200 is information output by the output unit 110, and includes data such as images, videos, text, and audio. The output information is classified into types such as information on a set destination or transit point, and information on surrounding facilities. The output unit 110 displays, for example, output information set by a user.

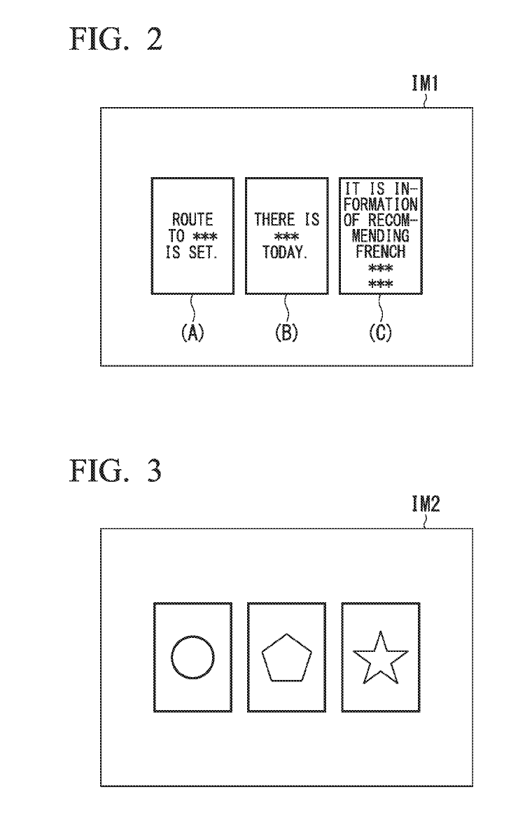

FIG. 2 is a diagram which shows an example of display contents of a display image IM1 displayed on the output unit 110. In the example of FIG. 2, text data is output to the output unit 110. A user sets, for example, arbitrary text data embedded in the display image IM1 in advance, and causes the output unit 110 to output information based on the text data during the starting processing of the vehicle information output device 100.

FIG. 3 is a diagram which shows an example of display contents of a display image IM2 displayed on the output unit 110. In the example of FIG. 3, image data is output to the output unit 110. A user sets, for example, arbitrary image data embedded in the display image IM1 in advance, and causes the output unit 110 to output information based on the text data during the starting processing of the vehicle information output device 100.

Image output information is, for example, image data such as a bitmap image or a vector image. If image data is transmitted to the server 200 from the terminal device 300 by the operation of a user, the server 200 saves the image data in the storage unit 206. At this time, the server 200 trims the image data to make it conform to a size on a display screen of the output unit 110 or may adjust a resolution on the basis of setting information K to be described below. The image output information may be a plurality of images displayed in a display image displayed on the output unit 110, and may also be an image displayed as wallpaper of the display image.

Video output information is, for example, video data encoded on the basis of a predetermined standard. If video data is transmitted to the server 200 from the terminal device 300 by the operation of a user, the server 200 saves the video data in the storage unit 206. At this time, the server 200 may trim the video data to make it conform to the size on the display screen of the output unit 110 or adjust a bit rate on the basis of the setting information K.

Text output information is text data including control information such as data, line feeds, and tabs represented by character codes such as characters. The text data is, for example, an arbitrary message, a message such as notification of reception of a mail, or the like. The text data may be, for example, generated by a user, or a simple message (short sentence) may be generated by the output control unit 136. The text data may be traffic information of a route to a destination or news acquired from the network.

If text data is transmitted from the terminal device 300 to the server 200 by the operation of a user, the server 200 saves the text data in the storage unit 206. At this time, the server 200 may change a control code such as a line feed to make the text data conform to a size in a display screen of the output unit 110, set a font size, or limit the number of characters on the basis of the setting information K.

Voice output information is, for example, voice data in which a waveform of voice is converted into quantized data on the basis of a predetermined standard. The voice output information is, for example, music, sound effects, or reading sound.

If voice data is transmitted from the terminal device 300 to the server 200 by an operation of a user, the server 200 saves the voice data in the storage unit 206. At this time, the server 200 may convert a format of the voice data or perform voice compression according to performance of a speaker of the output unit 110. The voice output information may be output from the output unit 110 only using voice or may also be output from the output unit 110 in combination with output information of an image, a video, and text.

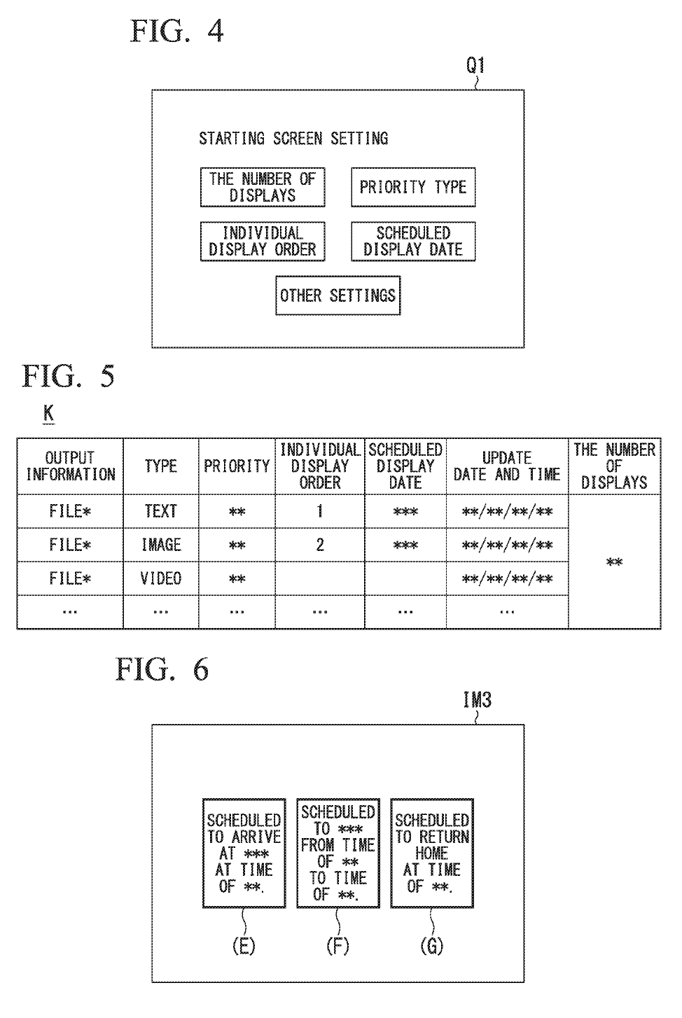

FIG. 4 is a diagram which shows an example of contents of a setting screen Q1 of the terminal device 300 for setting output information. In the setting screen Q1, for example, a setting item of a screen at the time of starting, which is displayed on the output unit 110, is indicated by an image of button. A user operates the setting screen Q1 at a timing of uploading output information to the server 200, and sets output information to be displayed on the output unit 110. The setting of output information may be updated by a user operating the setting screen Q1 at an arbitrary timing in addition to a timing of uploading the output information to the server 200.

For example, a user operates an operation button of “Thenumber of displays” in the setting screen Q1, and sets the number of pieces of output information to be displayed on the output unit 110. The user operates, for example, an operation button of “priority type” in the setting screen Q1, and sets a priority in accordance with a type of data such as images, videos, and text in the output information.

For the priority, for example, a user selects a level set in a stepwise manner in advance. The priority is updated to a level at the time set by a user. For example, for priority, data set by a user at the highest level at a present time is the highest, and a level of priority set in the past is sequentially lowered with respect to the latest setting. For example, in a case that a user wants to prioritize text data, priority of the text data is set higher than other types of output information such as images. A user operates a button of “priority type” in the setting screen Q1, and performs setting to display the text data in a preferential manner.

Priorities may be set for individual pieces of output information at a more detailed level in the types of data. A user operates, for example, an operation button of “individual display order” in the setting screen Q1, and selects data to be individually displayed. With this operation, if the user sets a display order of data, an increasing priority is assigned to data in a descending order, and a priority level set in the past is sequentially lowered with respect to the latest setting.

For example, a user operates an operation button of “scheduled display date” and sets a date for displaying output information. For example, the user operates the setting screen Q1 displayed on the terminal device 300 before getting into the vehicle 10, and inputs a date for displaying output information. Accordingly, the user can acquire predetermined output information at a specific date designated by the user. However, the operation button of “scheduled display date” may be omitted if only one type of output information can be selected.

The terminal device 300 transmits the contents set by the user to the server 200 as setting information K. The setting described above may be performed by the terminal device 300 or may also be performed in the vehicle information output device 100.

FIG. 5 is a diagram which shows an example of contents of the setting information K. The setting information K is information in which a file name of output information, a type of output information, a set priority, a set individual display order, a scheduled display date, an update date and time of data, the number of displays displayed on the output unit 110, and the like are associated with one another. These setting contents are transmitted to the server 200 as setting information, and stored in the storage unit 206.

The user operates, for example, the terminal device 300 before getting into the vehicle 10, and selects output information to be displayed on the output unit 110 at the time of starting processing of the vehicle information output device 100. The terminal device 300 transmits the setting information K to the server 200 on the basis of the operation of the user.

The user gets into the vehicle 10, and the power control unit 132 brings the vehicle information output device 100 into an ON state in conjunction with bringing the power supply of the vehicle 10 into an ON state. The starting unit 104 starts starting processing of the vehicle information output device 100. The communication control unit 134 accesses the server 200 via the communication unit 120 in conjunction with a start of the starting processing of the starting unit 104.

If communication between the vehicle information output device 100 and the server 200 is established, the selection unit 108 reads the setting information K from the server 200. The selection unit 108 selects output information associated with the number of displays displayed on the output unit 110 in a descending order of priority with reference to the setting information K.

When a priority is not set for output information, the selection unit 108 preferentially selects output information by setting an increasing priority in an order of a new transmission order of the output information uploaded to the server 200, for example. The selection unit 108 refers to data of update date and time of the setting information K, and preferentially selects output information in an order of new update date and time.

The output control unit 136 reads the selected output information from the server 200 and displays it on the output unit 110 according to a display order on the basis of a result of selecting output information using the selection unit 108.

When a high priority is set for text in the type of output information, for example, the output control unit 136 refers to the setting information K, and determines the number of displays and a display order of information to be displayed in a display image IM1 on the basis of a selection result of the selection unit 108.

The output control unit 136 causes the output unit 110 to output text data according to a set order in a case that an individual display order is set by a user in an order of, for example, a route to a destination, information input by a user, and information based on the preferences of a user.

The output control unit 136, for example, reads text data, extracts a keyword from contents of the text data, and generates a simple short sentence. The output control unit 136 generates a short sentence by, for example, applying a keyword extracted to a fixed phrase set in advance. For example, in a case that output information for notifying of a received mail and notifying of a route set by a user is output, the output control unit 136 extracts a keyword such as a destination, a transit point, or a time, and generates a predetermined short sentence.

In the example of FIG. 2, for example, the output control unit 136 determines to firstly display information (A) indicating that a route to a destination is set. The output control unit 136 generates a short sentence indicating that the destination is set.

Next, the output control unit 136 determines to secondly display information (B) input by a user. The output control unit 136 accesses the server 200 via the network NW, acquires information input by the user, and generates a short sentence on the basis of input data of the user.

Next, the output control unit 136 determines to thirdly display information (C) based on the preference of a user. The output control unit 136 collects information associated with the preference of a user via the network NW, and generates a short sentence that provides information. The output control unit 136 generates the display image IM1 that displays information of a text message. The output control unit 136 generates the display image IM1 in which the generated short sentence is indicated, and causes the output unit 110 to display the display image IM1.

In the example of FIG. 3, the output control unit 136 refers to the selection result of the selection unit 108 and the setting information K, and generates a display image IM2 in a case that a high priority is set for an image. The output control unit 136 reads a selected image from the server 200, generates the display image IM2 in which images associated with the number of displays are embedded according to the display order, and causes the output unit 110 to display the display image IM2.

The images displayed in the display image IM2 may be trimmed in advance on the basis of the setting information K to conform to a size of the display image IM2 on the server 200 side, and may be trimmed by the output control unit 136.

When a high priority is set for a video, the output control unit 136 refers to the selection result of the selection unit 108 and the setting information K, generates a display image in which a display portion of a video is embedded, and causes the output unit 110 to display the display image.

When a high priority is set for voice, the output control unit 136 refers to the selection result of the selection unit 108 and the setting information K, and causes the output unit 110 to sequentially output voice.

A display order is set individually among types of text data, image data, and video data, and thereby the output control unit 136 may generate a display image in combination with data of each type, and may cause the output unit 110 to output the display image. At this time, the output control unit 136 may also cause the display image to be output from a speaker included in the output unit 110 in appropriate combination with voice data.

In the vehicle information output device 100, in a case that starting processing executed by the starting unit 104 is completed, and an operation of a user is receivable, the output control unit 136 ends display control of the output unit 110.

According to the first embodiment described above, the vehicle information output system 1 can more flexibly determine information to be output after power is turned on until it is ready for use. The vehicle information output system 1 can provide information requested by a user during a time in which the starting processing is executed.

### Second Embodiment

In the first embodiment, output information selected by a user is displayed on the output unit 110 of the vehicle information output device 100. In a second embodiment, information on a schedule such as a schedule for a user is output to the output unit 110. The user can check the schedule of the day while the starting processing of the vehicle information output device 100 is performed.

FIG. 6 is a diagram which shows an example of the display contents of a display image IM3 displayed on the output unit 110. A user operates the setting screen Q1 of the terminal device 300 before getting on the vehicle 10, and selects an operation to cause the output unit 110 to display output information regarding a schedule of a user. The user operates, for example, a button of priority type in the setting screen Q1, and sets a higher priority for the schedule of a user in the output information.

When the schedule of a user is managed in the terminal device 300, the terminal device 300 uploads schedule data of a user to a schedule management server. The schedule management server is a server which manages the schedule of a user, and the server 200 may have this function. The schedule data is, for example, data generated in a data format of a standard calendar format, and is information in which a title, a date, a time, an event, and the like are associated with each other.

A user operates, for example, the terminal device 300 and causes the schedule data of a user stored in the storage unit 206 of the server 200 to be synchronized with the schedule data of a user managed in the terminal device 300. The terminal device 300 may automatically upload the schedule data of a user to the server 200 at a predetermined timing.

The selection unit 108 reads, for example, the schedule of a user included in the schedule data of a user from the storage unit 206 of the server 200. The selection unit 108 preferentially selects a schedule in chronological order. The selection unit 108 preferentially selects, for example, a chronologically earlier schedule of the day on which the vehicle 10 travels.

The selection unit 108 may preferentially select a schedule while a user is moving and a schedule after a user arrives at a destination. If the schedule of a user is input in detail and chronologically displayed, in a case that the schedule to the destination is not output to the output unit 110, the selection unit 108 extracts a destination schedule, a transit point schedule, the schedule after a user arrives at a destination, and the like from the selected schedule data.

The selection unit 108 selects text data according to a set order in a case that an individual display order is set in the schedule of a user. The output control unit 136 causes the text data to be output to the output unit 110 according to the set order on the basis of the selection result of the selection unit 108.

In the example of FIG. 6, the output control unit 136 determines to first display, for example, information (E) regarding the destination of a user. Next, the output control unit 136 determines to secondly display information (F) regarding the schedule while a user is moving. Then, the output control unit 136 determines to thirdly display information (G) regarding the schedule after a user arrives at the destination. The output control unit 136 accesses a server and the like that manage the schedule, and generates a short sentence regarding the schedule of a user on the basis of the schedule data of a user. The output control unit 136 generates a display image IM3 on the basis of the generated short sentence, and causes the output unit 110 to display the display image IM3.

According to the second embodiment described above, the vehicle information output system 1 can output the schedule of a user to the output unit 110 at the time of starting processing of the vehicle information output device 100. As a result, a user can effectively utilize a time before the starting processing ends.

[Processing Flow]

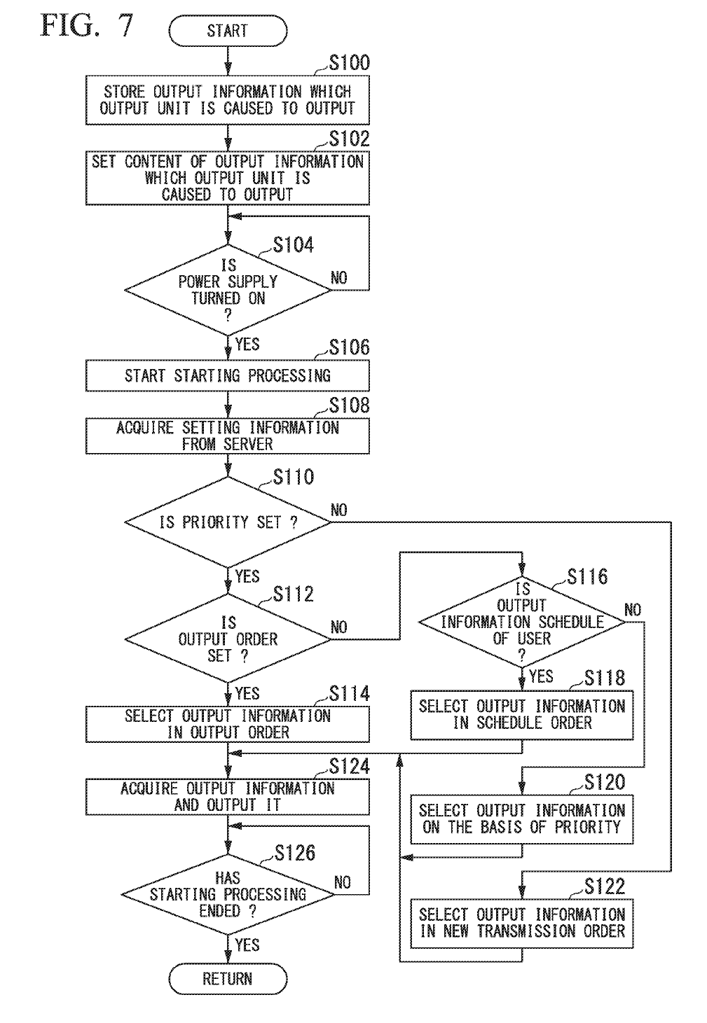

Next, processing executed in the vehicle information output system 1 will be described. FIG. 7 is a flowchart which shows an example of a flow of the processing executed in the vehicle information output system 1.

A user uploads output information which the output unit 110 is caused to output from the terminal device 300 to the server 200 (step S100). When the user is scheduled to get into the vehicle 10, the user operates the terminal device 300 and sets contents of output information displayed on the output unit 110 at the time of the starting processing of the vehicle information output device 100 (step S102). Setting information for causing the output unit 110 to display the output information is stored in the server 200.

The starting unit 104 monitors whether the power supply is turned on by the power control unit 132 (step S104). When a negative determination is obtained in step S104, the starting unit 104 repeats the processing of step S104. When a positive determination is obtained in step S104, the starting unit 104 starts the starting processing (step S106). The communication control unit 134 accesses the server 200 and acquires setting information (step S108).

The selection unit 108 refers to setting information and determines whether a priority is set for output information (step S110). When a positive determination is obtained in step S110, the selection unit 108 determines whether an order in which the output information is output is set (step S112). When a positive determination is obtained in step S112, the selection unit 108 selects output information according to the set order in which the output information is output (step S114). When a negative determination is obtained in step S112, the selection unit 108 determines whether a content of the output information is the schedule of a user (step S116).

When a positive determination is obtained in step S116, the selection unit 108 selects output information in an order of the schedule of a user (step S118). When a negative determination is obtained in step S116, the selection unit 108 selects output information on the basis of the priority (step S120). When a negative determination is obtained in step S110, the selection unit 108 selects output information in a new transmission order of output information transmitted to the server 200 (step S122). Next, the output control unit 136 acquires output information from the server 200 on the basis of the selection result of the selection unit 108, generates information in a predetermined output format on the basis of the acquired output information, and causes the output unit 110 to output the information (step S124).

The output control unit 136 determines whether the starting processing has ended (step S126). When a negative determination is obtained in step S126, the output control unit 136 repeats the processing of step S126. When a positive determination is obtained in step S126, processing of the flowchart ends. Each step described above may be appropriately replaced, or may be appropriately omitted.

[Hardware Configuration]

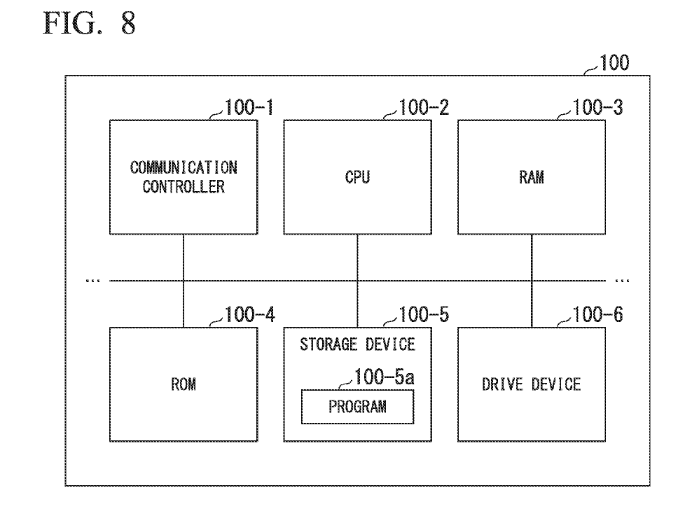

FIG. 8 is a diagram which shows an example of a hardware configuration of the vehicle information output device 100. As shown in FIG. 8, the vehicle information output device 100 applied to the vehicle information output system 1 of the embodiment has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive, a drive device 100-6, and the like are connected to one another by an internal bus or a dedicated communication line. The communication controller 100-1 communicates with a component other than the vehicle information output device 100. In the storage device 100-5, a program 100-5a executed by the CPU 100-2 is stored. This program is developed in the RAM 100-3 by a direct memory access controller (DMA) (not shown) and the like, and is executed by the CPU 100-2. As a result, some or all of a determination unit, a display control unit, a communication control unit, and a communication unit are realized.

The embodiments described above can be expressed as follows.

A vehicle information output device includes a storage device which stores a program, and a hardware processor, in which the hardware processor executes a program stored in the storage device, and thereby outputting information to inside of a vehicle using an output unit, executing starting processing in a case that the power supply is turned on, communicating with an external device via a network, acquiring output information stored in the external device via the communication unit, and outputting the acquired output information to an output unit before starting processing by the starting unit is completed.

As described above, although a mode for carrying out the present invention has been described using the embodiments, the present invention is not limited to these embodiments, and various modifications and substitutions can be added within a scope not deviating from the gist of the present invention. For example, in the embodiments described above, a case in which the selection unit is provided in the vehicle information output device is exemplified, but it may be provided on a server side.

What is claimed is:

1. A vehicle information output device comprising:
an output unit configured to output information to inside of a vehicle;
a starting unit configured to execute starting processing in a case that the power supply is turned on;
a communication unit configured to communicate with an external device via a network;
a communication control unit configured to acquire output information stored in the external device via the communication unit; and
an output control unit configured to cause the output unit to output the output information acquired by the communication control unit before starting processing by the starting unit is completed.

2. The vehicle information output device according to claim 1,
wherein an operation of a user is receivable after the starting processing executed by the starting unit is completed.

3. The vehicle information output device according to claim 1, further comprising:
a selection unit configured to select the output information according to a type,
wherein the output control unit causes the output unit to output an image based on the output information selected by the selection unit.

4. The vehicle information output device according to claim 3,
wherein a priority is set for the output information in accordance with a type of the output information in a case that the output information is transmitted to a server by a user, and
the selection unit selects the output information on the basis of the priority.

5. The vehicle information output device according to claim 3,
wherein the selection unit preferentially selects the output information transmitted to a server by an operation of a user.

6. The vehicle information output device according to claim 3,
wherein the selection unit preferentially selects the output information in a new transmission order of the output information transmitted to a server by the operation of a user.

7. The vehicle information output device according to claim 3,
wherein, in a case that the output information is a schedule of a user, the selection unit preferentially selects the schedule in chronological order.

8. The vehicle information output device according to claim 3,
wherein, in a case that a destination of the vehicle is set, the selection unit preferentially selects a schedule while a user is moving and a schedule after the user arrives at the destination.

9. A vehicle information display system which includes a vehicle information display device mounted on a vehicle and a server capable of communicating with the vehicle,
the vehicle information display device including
an output unit configured to output information to inside of the vehicle,
a starting unit configured to execute starting processing in a case that the power supply is turned on,
a communication unit configured to communicate with the server via a network,
a communication control unit configured to acquire output information stored in the server via the communication unit, and
an output control unit configured to cause the output unit to output the output information acquired by the communication control unit before starting processing by the starting unit is completed.
